(19) United States
(12) Patent Application Publication
(10) Pub. No.: US 2024/0280079 A1
(43) Pub. Date: Aug. 22, 2024

(54) MULTI-AXIS ELECTRICTY GENERATOR

(71) Applicant: WISP ENERGY, LLC, Boca Raton, FL (US)

(72) Inventor: Scott Jewett, Boca Raton, FL (US)

(21) Appl. No.: 18/583,761

(22) Filed: Feb. 21, 2024

Related U.S. Application Data
(60) Provisional application No. 63/447,564, filed on Feb. 22, 2023.

(51) Int. Cl. F03D 5/02; H02K 7/10; H02K 7/116; H02K 7/18

(52) U.S. Cl. CPC F03D 5/02; H02K 7/1004; H02K 7/116; H02K 7/183; F05B 2220/706

(57) ABSTRACT

A multi-axis electricity generator is provided which includes a support member, a hub assembly, a plurality of sails, and an electricity generator. The hub assembly includes a conveyor which includes a belt and a pair of pulleys. The belt forms a generally oval loop around the pulleys so that the belt loop includes two straight sections and two semicircular sections. Preferably, hub extends in generally a horizontal direction so that the belt's straight sections are substantially horizontal. Sails extend from the belt loop so that fluid movement (wind or water) pushes the sails and causes the belt to move and thus cause the pulley to rotate. The pulley is connected to the electric generator to provide electricity. Preferably, the sails are extendable when traveling with the wind and collapsible when traveling into the wind. Also preferably, the hub assembly is capable of rotating about a substantially vertical axis and tilting about a horizontal axis.

### CROSS-REFERENCE TO RELATED APPLICATIONS

The present application claims priority to U.S. Provisional Patent Application No. 63/447,564, filed Feb. 22, 2023, which is incorporated herein by reference in its entire

### BACKGROUND OF THE INVENTION

The present invention relates to wind turbines. More particularly, the present invention relates to wind turbines with improved efficiencies.

Wind turbine generators utilize wind energy to produce electrical power. The most popular wind turbine generators typically include a wind rotor having multiple blades that rotate about a horizontal axis to transform wind energy into rotational motion of a drive shaft, which in turn is utilized to drive a rotor of an electrical generator to produce electrical power. These traditional 3-blade wind turbines cost millions of dollars, make disruptive noise, have high maintenance costs, and kill birds.

An alternative wind turbine is the vertical axis wind turbine. A vertical axis wind turbine has blades mounted on the top of the main shaft structure, rather than in the front like an aircraft rotor. The generator is usually placed at the tower base. Vertical axis wind turbines are more practical in residential areas. A first popular vertical axis design resembles two halves of a 55-gallon drum, each mounted to the rotating element (Savonius rotor). A second smaller model looks somewhat like an egg beater, and is referred to as a Darrieus model. Unfortunately, these vertical axis designs are inefficient, typically producing less energy than horizontal axis turbine as some blades must rotate upstream of the direction of wind while other blades are forced downstream by the wind.

Thus, there is a need for wind turbine that provides improved efficiency compared to horizontal axis and vertical axis wind turbines.

Furthermore, there is a need for a need for a wind turbine that is less disruptive to the environment, such as creating noise or harming birds.

### SUMMARY OF THE INVENTION

A multi-axis electricity generator is provided which includes a support member, a hub assembly, a plurality of sails, and an electric generator. The support member is any mechanical structure, such as bracketry or a tower, intended to support the hub assembly above the ground.

The hub assembly includes a conveyor which includes a belt and at least a pair of pulleys. Preferably, the belt and two pulleys forms a generally oval loop around the pulleys so that the belt loop includes two straight sections and two semicircular sections. Preferably, hub extends in generally a horizontal direction so that the belt's straight sections are substantially horizontal. The sails are affixed to the belt loop sail supports which extend from the belt loop so that fluid movement (wind or water) pushes the sails and causes the belt to rotate. In turn, the belt is connected either directly or by gears or by a transmission to the electric generator to provide electricity.

The sails are extendable when traveling with the wind and collapsible when traveling into the wind. Also preferably, the hub assembly is capable of rotating about a substantially vertical axis and tilting about a horizontal axis. The multi-axis electricity generator may include various sensors, drive motors and a controller for optimizing electricity generation. Preferably, drive motors control both yaw and pitch of the hub assembly. The multi-axis electricity generator may, or may not, include additional drive motors to control the collective or individual rotation, alignment, expansion or collapse of the sails. Preferably, the controller includes memory for recording sensor data (including wind speed, wind direction, hub orientation, and sail alignment) and a processor for recording sensor data and for applying artificial intelligence to analyze such data for improving and maximizing the position of the various components to maximize electricity generation.

### BRIEF DESCRIPTION OF THE DRAWINGS

FIG. 1 is a first perspective view of the hub and sail assemblies of the multi-axis wind turbine illustrating its operation within wind flow;

FIG. 2 is a partially exploded perspective view of the hub and sail assemblies of the multi-axis wind turbine shown in FIG. 1;

FIG. 3 is perspective view of the multi-axis wind turbine shown in FIG. 1 illustrating its operation within wind flow;

FIG. 4 is an additional perspective view of the multi-axis wind turbine shown in FIG. 1 illustrating its operation within wind flow;

FIG. 5 is still an additional perspective view of the multi-axis wind turbine shown in FIG. 1 illustrating its operation within wind flow;

FIG. 6A is a perspective view illustrating a preferred hinge assembly with the sails in a collapsed condition;

FIG. 6B is a perspective view illustrating a preferred hinge assembly with the sails in a partially open-partially collapsed condition;

FIG. 6C is a perspective view illustrating a preferred hinge assembly with the sails in an open condition;

FIG. 7 is a first perspective view of second embodiment of a multi-axis wind turbine;

FIG. 8 is a second perspective view of the hub and sail assemblies of the multi-axis wind turbine shown in FIG. 7 illustrating its operation within wind flow;

FIG. 9 is a perspective view of third embodiment of a multi-axis wind turbine illustrating wherein the sails have constructions similar to sails found on sailboats;

FIG. 10 is a top plan view of a multi-axis wind turbine illustrating it rotational yaw capabilities; and

FIG. 11 is a side elevation view of a multi-axis wind turbine illustrating it hub assemblies tilt capabilities.

### DETAILED DESCRIPTION OF THE INVENTION

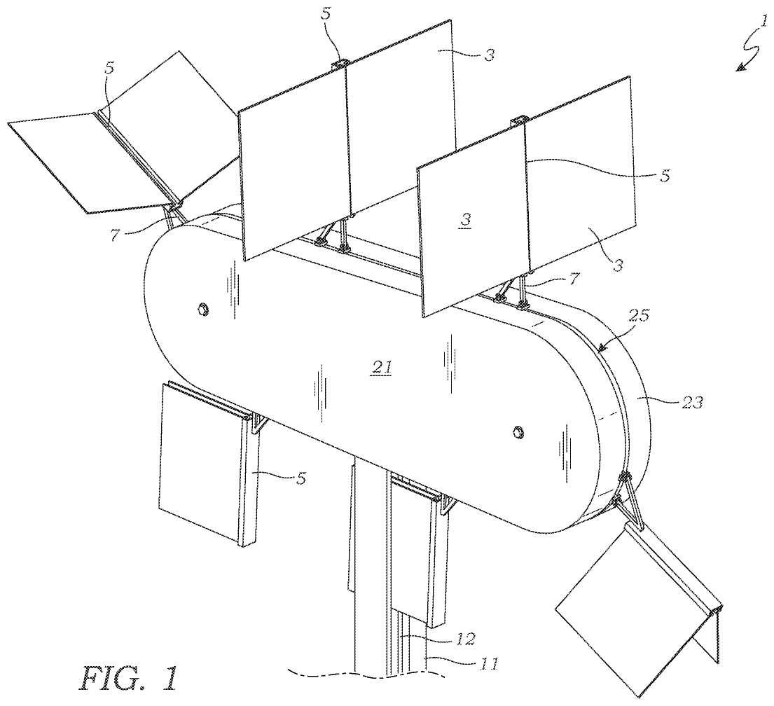

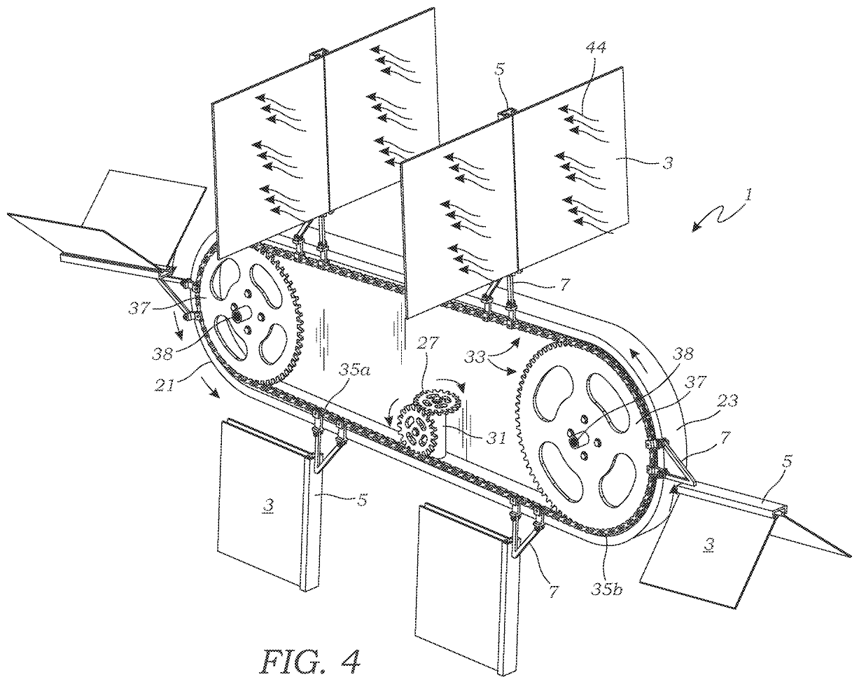

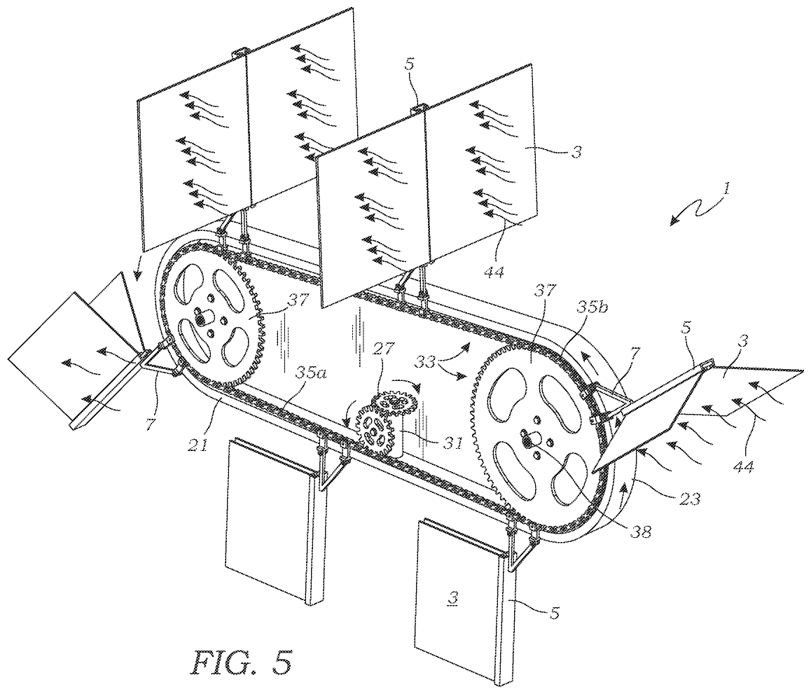

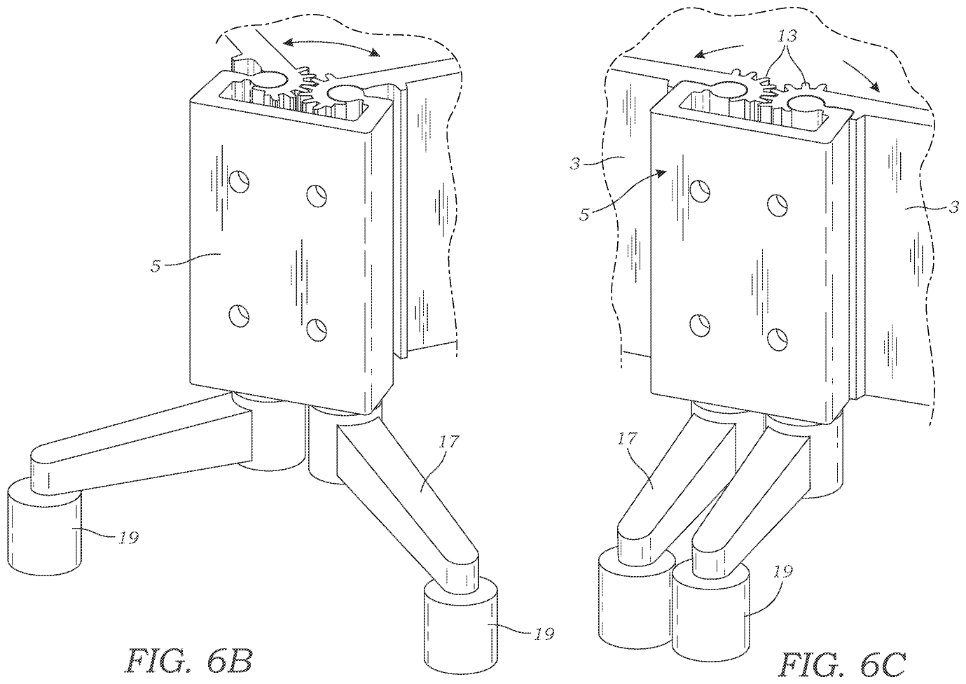

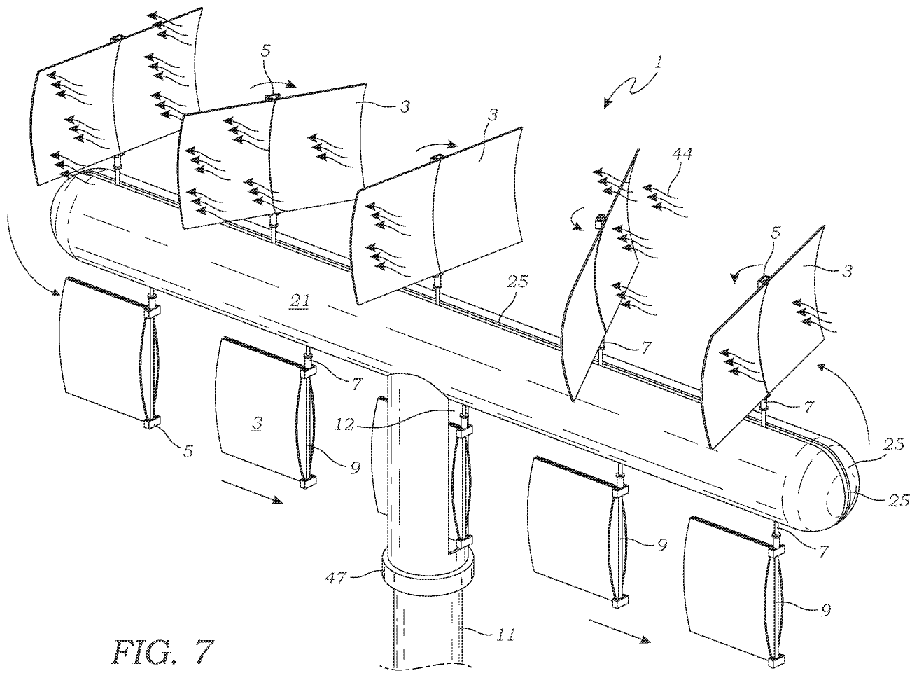

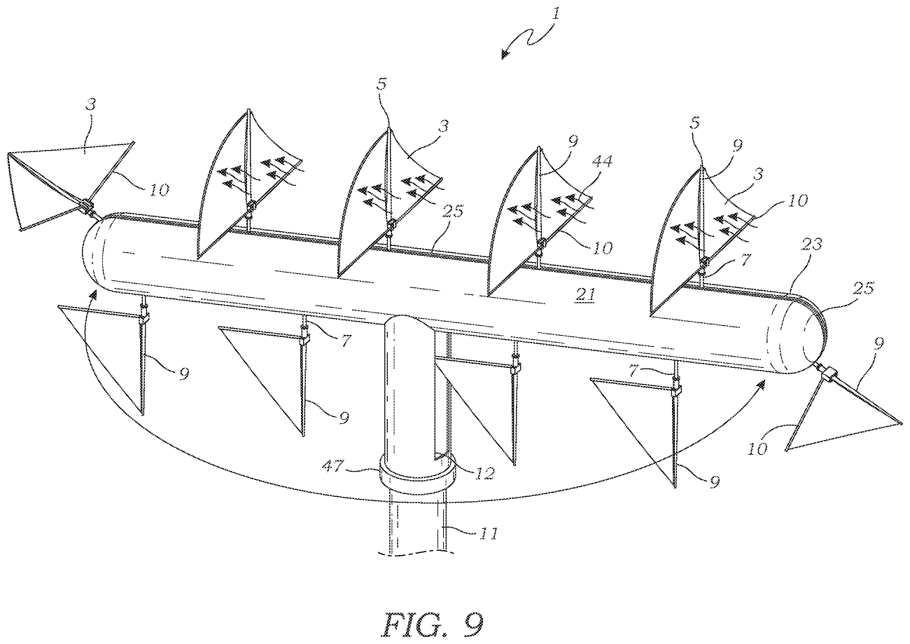

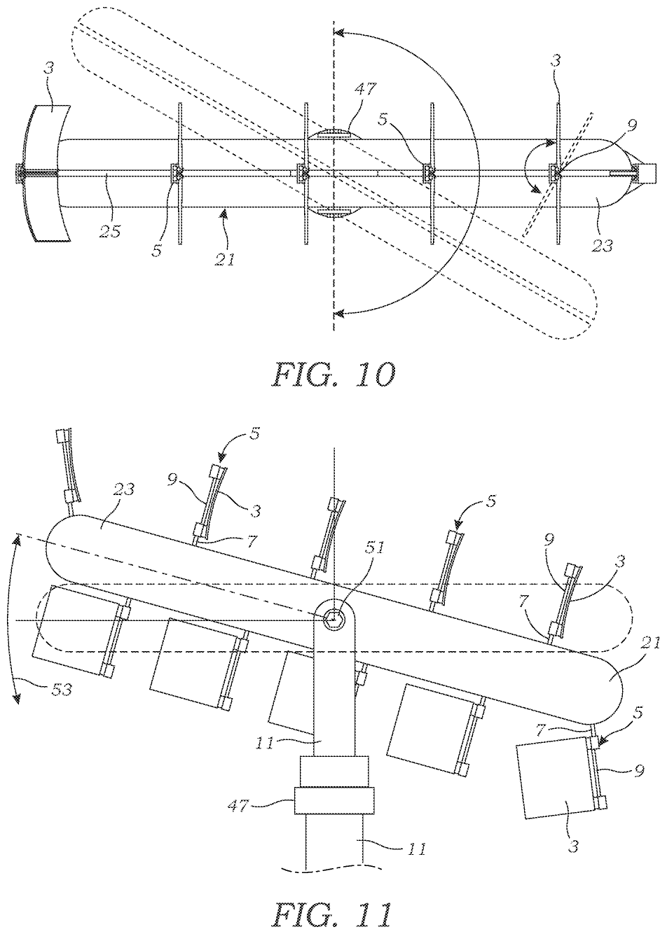

With reference to FIGS. 1-11, the multi-axis electricity generator provides a novel design for a wind-driven (or fluid-driven) turbine that converts the kinetic energy of fluid/air flow into rotational force, driving a generator that convert kinetic energy into electricity. Though capable of being used in a fluid, such as a river or tidal area, the multi-axis turbine 1 is described herein for use as a wind turbine. The multi-axis wind turbine 1 includes three primary components including a plurality of sails 3, a hub assembly 21 and a support member 11. As explained in greater detail below, for purposes herein, the term “multi-axis” refers to the sails collectively rotating about a first axis, and the sails individually folding about a second axis. In addition, the various components may also rotate about various additional axis to increase energy collection. For example, as illustrated in FIGS. 7 and 8, the sails 3 may rotate individually about their respective support axes. Furthermore, as illustrated in FIG. 10, the hub assembly 21 may rotate about a vertical axis to provide yaw control, and as illustrated in FIG. 11, the hub assembly 21 may swivel about a horizontal axis to provide tilt control.

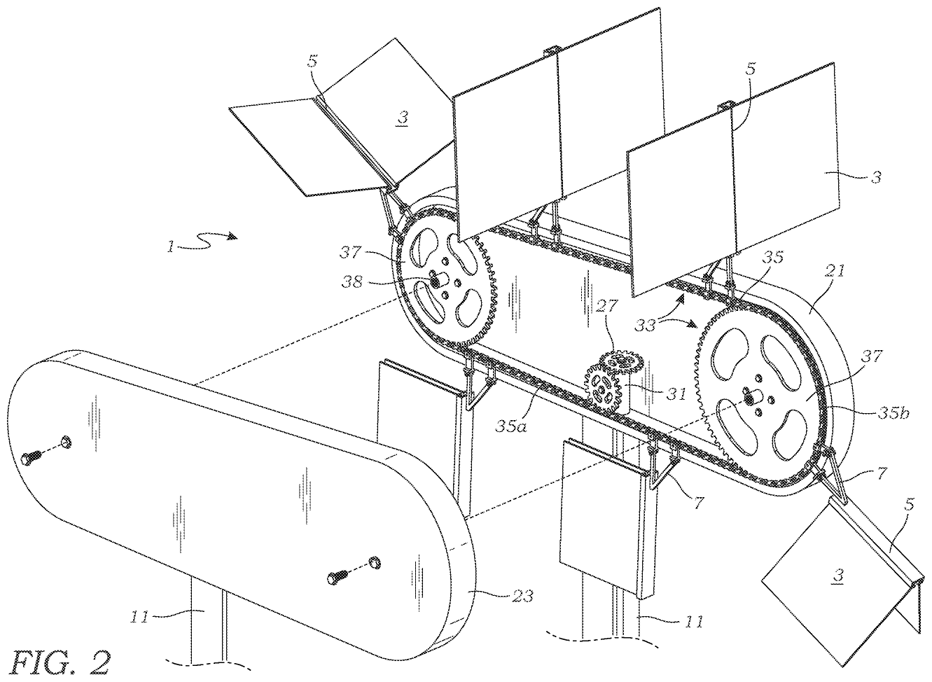

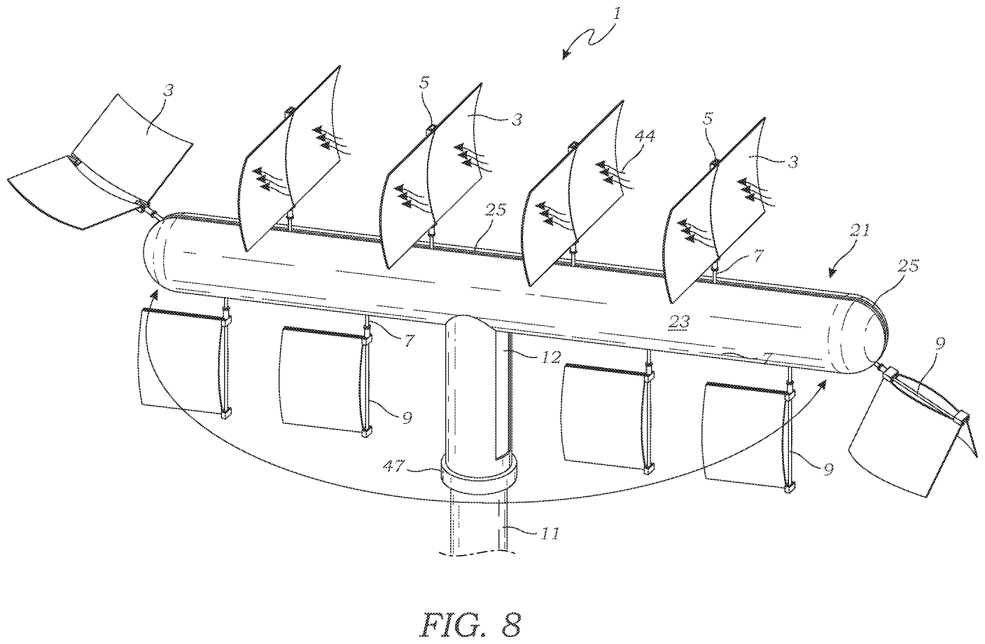

As illustrated in FIGS. 1-5 and 7-11, the hub assembly 21 is mounted on the support mechanism 11, and the sails 3 are affixed to and rotate about the hub assembly. The support mechanism 11 may comprise simply bracketry, beams or frame, such as shown in FIGS. 1 and 2, to support the hub assembly 21 above the ground or atop a building. Alternatively, as illustrated in Figs. support mechanism 11 is constructed as a cylindrical tower to support the hub assembly 21 above the ground or upon a building. In preferred embodiments, the towers 11 may be retrofits of the towers supporting existing three blade, horizontal axis wind turbines. More specifically, the preferred application for the multi-axis wind turbine 1 is to replace traditional wind turbines with a lower cost, better performing, quieter and safer turbine. As illustrated in FIGS. 1 and 9, the support member 11 may include a slot 12 for allowing the sail assemblies to pass through.

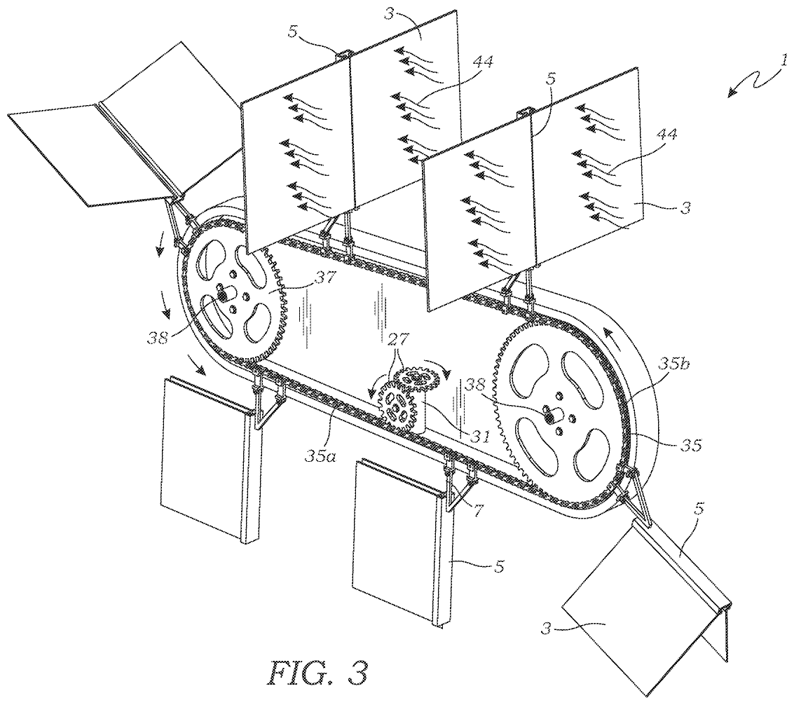

As illustrated in FIGS. 7-11, preferably the hub assembly 21 can rotate both about a vertical axis and tilt about a horizontal axis. To permit the hub assembly 21 to rotate about the vertical axis, the vertical support member 11 may rotate upon the foundation upon which it sits, such as the ground or building. However, as shown in FIGS. 7-10, preferably the hub assembly 21 is rotatably connected to the support member 11 by a rotatable connection 47. Though not shown, preferably, the multi-axis wind turbine 1 includes a yaw drive, including an electric motor, that rotates the hub assembly to the desired angle with respect to the wind direction. In a first embodiment, the hub assembly's longitudinal axis is aligned to face directly into the wind 44, such as represented in FIGS. 3-5. Alternatively, the hub assembly is intentionally rotated so that its longitudinal axis is offset relative to the direction of the wind 44 so as maximize the impact of wind 44 upon the sails 3. With reference to FIG. 10, in preferred operations, the hub assembly 21 is rotated 10°-90° relative to the direction of the wind 44. Where the hub assembly's rotational alignment is offset relative to the direction of the wind 44, preferably the sails 3 are also rotated to maximize the force imparted by the wind upon the sails 3. Rotation of the sails may be accomplished with or without individual electric motors to align the sails in a desired orientation.

With reference to FIG. 11, preferably the hub assembly 21 is connected to the support member 11 by a pitch connection 51 to permit the hub assembly 21 to rotate about a horizontal axis. Preferably, multi-axis wind turbine 1 includes a tilt drive (not shown) which includes and electric motor for adjusting the pitch angle of the hub assembly. In a first embodiment shown in FIGS. 1-5 and 7-10, the hub assembly's horizontal axis is aligned level with the Earth, in other words, at a 90° with respect to support member 11 in the event that the support member is aligned vertically). Alternatively, the hub assembly is intentionally tilted so that its longitudinal axis is offset relative to horizontal so as maximize the impact of wind 44 upon the sails 3. With reference to FIG. 11, in preferred operations, the hub assembly 21 is tilted 0°-90° relative to horizontal.

The hub assembly 21 includes a nacelle 23 which houses all of the traditional electro-mechanical components typically found in a horizontal or vertical wind turbine, including a gear box, transmission, generator, yaw drive, and controller. Though not shown, the hub assembly 21 preferably includes an externally mounted anemometer and wind vane. The yaw drive (not shown) permits rotation of the hub assembly about the vertical axis. Meanwhile, a pitch drive (not shown) controls the pitch of the hub assembly 21 relative to the horizontal axis. The generator (represented as 31) is connected to the transmission and converts mechanical energy to electrical energy. Preferably, the transmission includes a highly efficient variable transmission so as to maximize energy capture from the wind and to reduce loss through mechanical friction or the like. For example, a hard geared Infinitely Variable Transmission can be incorporated into the gearbox.

Meanwhile, the controller is connected to the various electromechanical components and sensors (including anemometer and wind vane) to monitor, maximize, and safely produce electrical energy. In operation, the anemometer senses the wind direction and wind speed and transmits this information to the controller, which in turn, then varies the gear rations to maintain optimal efficiency. The controller also signals yaw drive and pitch drive to rotate and tile the hub assembly 21 into the optimal angle to the flow. With reference to FIG. 7, where the sails 3 can be collectively or individually rotated or otherwise adjusted, preferably the controller is also connected to the sails 3 to control their operation to maximize energy generation. Preferably, the controller records various environmental conditions (including wind speed and angle) and operational conditions (including yaw, pitch, sail angle, and electricity generation) to provide a database for further analysis. Preferably, artificial intelligence/machine learning is employed to analyze this database in order to maximize electricity generation based on current conditions.

In addition, hub assembly 21 includes a conveyor belt type assembly for permitting rotation of the sails 3 about the hub assembly. As illustrated in FIGS. 1 and 2, the conveyor belt type assembly includes a belt 35 and two or more pulleys 37. For purposes herein, the term “belt” is intended to be interpreted broadly to include any loop construction including a traditional conveyor belt, V-belt, cable, linear linkage, or chain. Similarly, the term “pulley” is intended to be interpreted broadly to include any rotating drive element including a traditional pulley, gear or sprocket. As a result of having two or more pulleys, the belt 35 will form a loop including at least two straight sections 35a and at least two semicircular sections 35b. As illustrated in FIGS. 1-5 and 7-11, wind 44 is intended to

Each of the plurality of sails 3 of the multi-axis wind turbine are connected to the conveyor belt assembly by a sail support 7 which extends through a slot 25 in the nacelle from the conveyor belt assembly 33 to the sails 3. The sail supports 7 may be simple brackets or beams. Alternatively, as illustrated in FIG. 7, the sail supports 7 may swivel to maximize or minimize the sails' engagement with the wind. The conveyor belt 35 rotates so that the sails are intended to be perpendicular to the direction of the wind so that the sails move either (directly or at an offset angle) in the direction of wind flow, or (directly or at an offset angle) into the direction of wind flow. This includes a longitudinal section 35a which allows for a prolonged linear path for the sails 3 in the direction of the wind. This permits for an improved capture of wind flow into mechanical energy, which in turn is converted into electrical energy. Preferably, the conveyor belt 35 rotates about an oval shape including two straight sections 35a and two semicircular sections 35b, and the oval's major axis defines the hub assembly's longitudinal axis. Alternatively, where the conveyor belt assembly includes more than two pulleys 37 so that the belt loop is not oval, then hub assembly's longitudinal is intended to be defined by the belt's loop's straight section 35a where wind imparts a force upon the belt 35 to cause its rotation.

The sails 3 are illustrated in the FIGS. 1 - 5 as flat panels. However, the sails 3 may be designed to have a variety of sizes and shapes to capture wind energy. For example, the sails 3 are illustrated as having an arcuate shape in FIGS. 7 and 8. Meanwhile, the sails 3 may have a similar construction to sails found on sailboats. For example, in an embodiment illustrated in FIG. 9, the sail 3 may be made of a flexible fabric material, and the sail support 7 may include a mast 9 and a boom 10. As illustrated in FIG. 9, the sails 3 may include two triangular sail sections. Alternatively, the sails 3 may include only a single sail section.

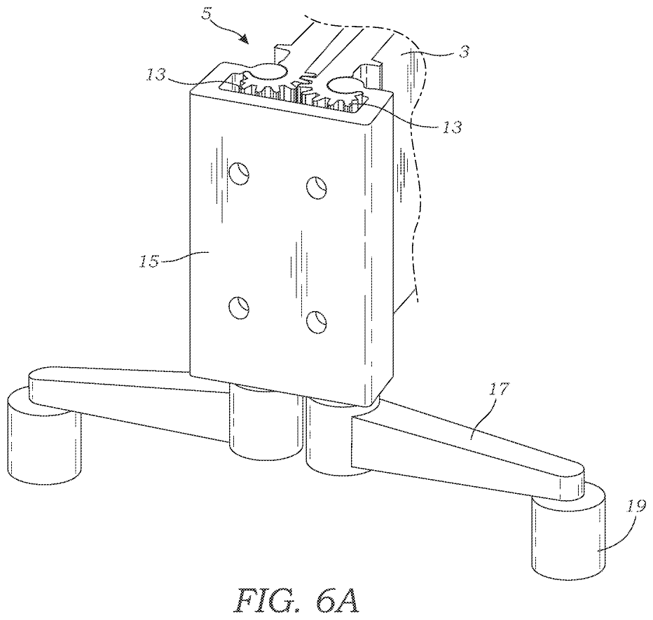

Sails 3 are supported by support assemble 7 that is constructed to allow anemometer feedback to rotate the entire assembly to optimize efficiency and/or for sails 3 be additionally angled in reference to wind flow to maximize airfoil effects. In addition, the sails 3 are constructed to rotate, bend or flex in order to minimize their cross-sectional area when travelling upwind. As best illustrated in FIGS. 6, in a preferred embodiment, the sails 3 include either a geared 13 or non-geared hinge which permits the sails 3 to collapse together when traveling in an upwind direction, and expand when travelling in a downwind direction. The sails 3 may expand and collapse solely due to forces exerted by the wind and/or gravity. Alternatively, each sail 3 may include one or more mechanical structures, such as lever arms 19, for biasing the panels into an expanded (increased surface area) condition so as to face the wind when travelling downwind, or for biasing the panels 3 into a collapsed (decreased surface area) and/or rotated condition avoiding the wind when traveling upwind. For example, the hub assembly nacelle 23 may include one or more abutments (not shown) that engage lever arm rollers 19, which in turn cause the lever arms 17 to either rotate inward to expand the sails 3, or to causes the lever arms 17 to rotate outward to retract the sails 3. Alternatively, the sails 3 may include electro-mechanical devices such pneumatic or mechanical actuators which are triggered passively or actively by the controller to expand the sails when they travel downwind, or which are triggered passively or actively by the controller to collapse and/or turn the sails 3 when they travel upwind.

The multi-axis wind turbine provides numerous advantages over the prior art. The conveyor belt assembly allows that sails to travel downwind in an optimized path rather than be restricted to rotational movement provided by horizontal and vertical axis turbines. Further, the dual-axis capability permits the sails to either turn or fold to take a low-resistance path back upwind. A nacelle may be used to house the sails during their upwind path.

The overall speed of the sails of the multi-axis wind turbine will be slower than the tips of traditional wind turbines, thereby reducing the number of birds killed and reducing noise and vibration. The slower speed further reduces the erosion of the sails that is caused by the high-speed impact of dust and particulate in the wind.

The sails may be larger in surface area than traditional three sail turbines. The sails may be constructed of traditional materials or be sail-like with a sheet stock stretched over a frame. Photovoltaic panels may be added to the sails for added energy production.

While several particular forms of the invention have been illustrated and described, it will be apparent that various modifications can be made without departing from the spirit and scope of the invention. Accordingly, it is not intended that the invention be limited except by the following claims.

I claim:

1. An energy generator comprising:
a vertically extending support member;
a hub assembly attached to the top of said support member, said hub assembly including a pair of pulleys, a belt wrapped around said pair of pulleys to form a belt loop with said belt loop including two straight sections and two semicircular sections, said hub assembly including said two belt loop straight sections which extend at least partially horizontally;
a plurality of sail assemblies with each sail assembly including a mast and a sail, said mast including a proximal end attached to said belt and a distal end attached to one of said sails; and
an electric generator connected to at least one of said pulleys so that the rotation of said pulleys creates electricity.

2. The energy generator of claim 1 wherein each of said sails include a hinge enabling said sail to expand or collapse.

3. The energy generator of claim 1 wherein each of said sails includes a hinge enabling said sail to expand or collapse with said sail collapsing when rotating upon said belt into the wind and said sail expanding when rotating upon said belt with the wind.

4. The energy generator of claim 1 further comprising a connection assembly which connects said hub assembly to said support member, said connection assembly including a pitch connection which permits said hub assembly to tilt relative to said support member.

5. The energy generator of claim 4 further comprising a tilt motor with the operation of said tilt motor controlling the angle of the hub assembly's tilt relative to said support member.

6. The energy generator of claim of claim 1 wherein said hub assembly including said two belt loop straight sections form a hub assembly axis, and said hub assembly axis tilts 0°-90° from horizontal.

7. The energy generator of claim 1 wherein said hub assembly including said two belt loop straight sections form a hub assembly axis, and said hub assembly axis tilts 0°-90° from horizontal.

8. The energy generator of claim 1 further comprising a connection assembly which connects said hub assembly to said support member, said connection member including a yaw connection which permits said hub assembly to rotate relative to said support member.

9. The energy generator of claim 8 further comprising a rotation motor with the operation of said rotation motor controlling the angle of the hub assembly's rotation relative to said support member.

10. The energy generator of claim of claim 1 wherein said hub assembly including said two belt loop straight sections form a hub assembly axis, and said hub assembly axis is rotationally aligned 0°-90° from the direction of the wind.

11. The energy generator of claim 1 wherein said hub assembly including said two belt loop straight sections form a hub assembly axis, and said hub assembly axis is rotationally aligned 0°-90° from the direction of the wind.

12. The energy generator of claim 1 further comprising a connection assembly which connects said hub assembly to said support member, said connection assembly including a yaw connection which permits said hub assembly to rotate relative to said support member and a pitch connection which permits said hub assembly to tilt relative to said support member.

13. The energy generator of claim 1 wherein said belt loop includes two straight sections and two 180° semicircular sections.
